(19) United States
(12) Patent Application Publication
(10) Pub. No.: US 2025/0367864 A1
(43) Pub. Date: Dec. 4, 2025

(54) INJECTION MOLDING DEVICE AND INJECTION MOLDING DIE

(71) Applicant: SEIKO EPSON CORPORATION, Tokyo (JP)

(72) Inventor: Masayuki TAKAHASHI, SHIOJIRI-SHI (JP)

(21) Appl. No.: 19/218,735

(22) Filed: May 27, 2025

(30) Foreign Application Priority Data
May 30, 2024 (JP) 2024-087690

(51) Int. Cl. B29C 45/37; B29C 45/04; B29C 45/20

(52) U.S. Cl. CPC B29C 45/37; B29C 45/20; B29C 45/0416

(57) ABSTRACT

An injection molding device includes a molding die including a fixed die and a movable die, a probe with a probe flow path through which a plasticized material is injected toward a cavity formed by the molding die, and a partition member. The fixed die includes a first plate with a first through hole that communicates with a second through hold of and a second plate. The probe is disposed in the first through hole and the second through hole. A first space is formed between an outer peripheral surface of the probe and an inner wall surface of the first through hole. A second space is formed between the outer peripheral surface and an inner wall surface of the second through hole. The partition member is disposed in the first through hole or the second through hole to surround the probe and partition the first and second spaces.

The present application is based on, and claims priority from JP Application Serial Number 2024-087690, filed May 30, 2024, the disclosure of which is hereby incorporated by reference herein in its entirety.

### BACKGROUND

### Technical Field

The present disclosure relates to an injection molding device and an injection molding die.

### Related Art

For example, JP-A-2012-20472 discloses a hot runner device including a hot runner nozzle and a hot runner mold. The hot runner nozzle is inserted into a nozzle attachment hole of a fixed die and a heat insulating space is formed between the hot runner nozzle and the fixed die.

JP-A-2012-20472 is an example of the related art.

In an injection molding device in which a space is formed between a probe that injects a plasticized material into a cavity and a through hole of a fixed die into which the probe is inserted, injection molding is generally executed after the plasticized material is filled in the space. However, when the through hole is formed over a plurality of members configuring the fixed died, there is a problem in that it is difficult to remove a resin cap formed by the plasticized material filled in the space being solidified.

### SUMMARY

According to a first aspect of the present disclosure, an injection molding device is provided. The injection molding device includes: a molding die including a fixed die and a movable die; a probe in which a probe flow path through which a plasticized material flows is provided, the probe injecting the plasticized material toward a cavity formed by the fixed die and the movable die; and a partition member. The fixed die includes: a first plate in which a first through hole is provided; and a second plate located between the first plate and the movable die, a second through hole communicating with the first through hole being provided in the second plate, the probe is disposed in the first through hole and the second through hole, a first space is formed between an outer peripheral surface of the probe and an inner wall surface of the first through hole, a second space is formed between the outer peripheral surface of the probe and an inner wall surface of the second through hole, and the partition member is disposed in the first through hole or the second through hole to surround the probe and partitions the first space and the second space.

According to a second aspect of the present disclosure, an injection molding die is provided. The injection molding die includes: a fixed die; a movable die; a probe in which a probe flow path through which a plasticized material flows is provided, the probe injecting the plasticized material toward a cavity formed by the fixed die and the movable die; and a partition member. The fixed die includes: a first plate in which a first through hole is provided; and a second plate located between the first plate and the movable die, a second through hole communicating with the first through hole being provided in the second plate, the probe is disposed in the first through hole and the second through hole, a first space is formed between an outer peripheral surface of the probe and an inner wall surface of the first through hole, a second space is formed between the outer peripheral surface of the probe and an inner wall surface of the second through hole, and the partition member is disposed in the first through hole or the second through hole to surround the probe and partitions the first space and the second space.

### BRIEF DESCRIPTION OF THE DRAWINGS

FIG. 1 is a top view illustrating a schematic configuration of an injection molding device.

FIG. 2 is a perspective view illustrating the schematic configuration of the injection molding device.

FIG. 3 is a cross-sectional view illustrating a schematic configuration of an injection unit.

FIG. 4 is a perspective view illustrating a schematic configuration of a flat screw.

FIG. 5 is a schematic plan view of a barrel.

FIG. 6 is a cross-sectional view illustrating a schematic configuration of a molding die.

FIG. 7 is an enlarged view illustrating a partial range AR of FIG. 6.

FIG. 8 is a diagram illustrating a state in which a plasticized material is filled in a second space.

### DESCRIPTION OF EMBODIMENTS

### A. First Embodiment:

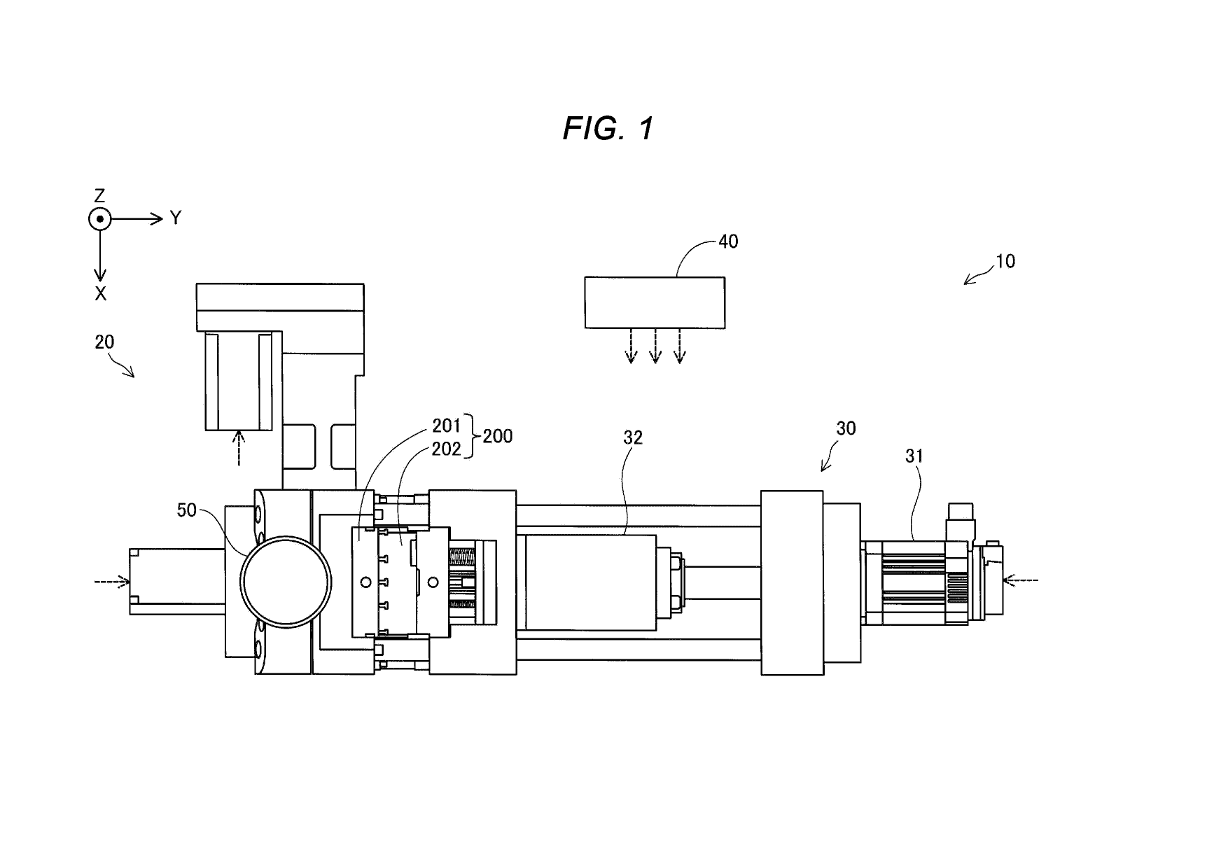

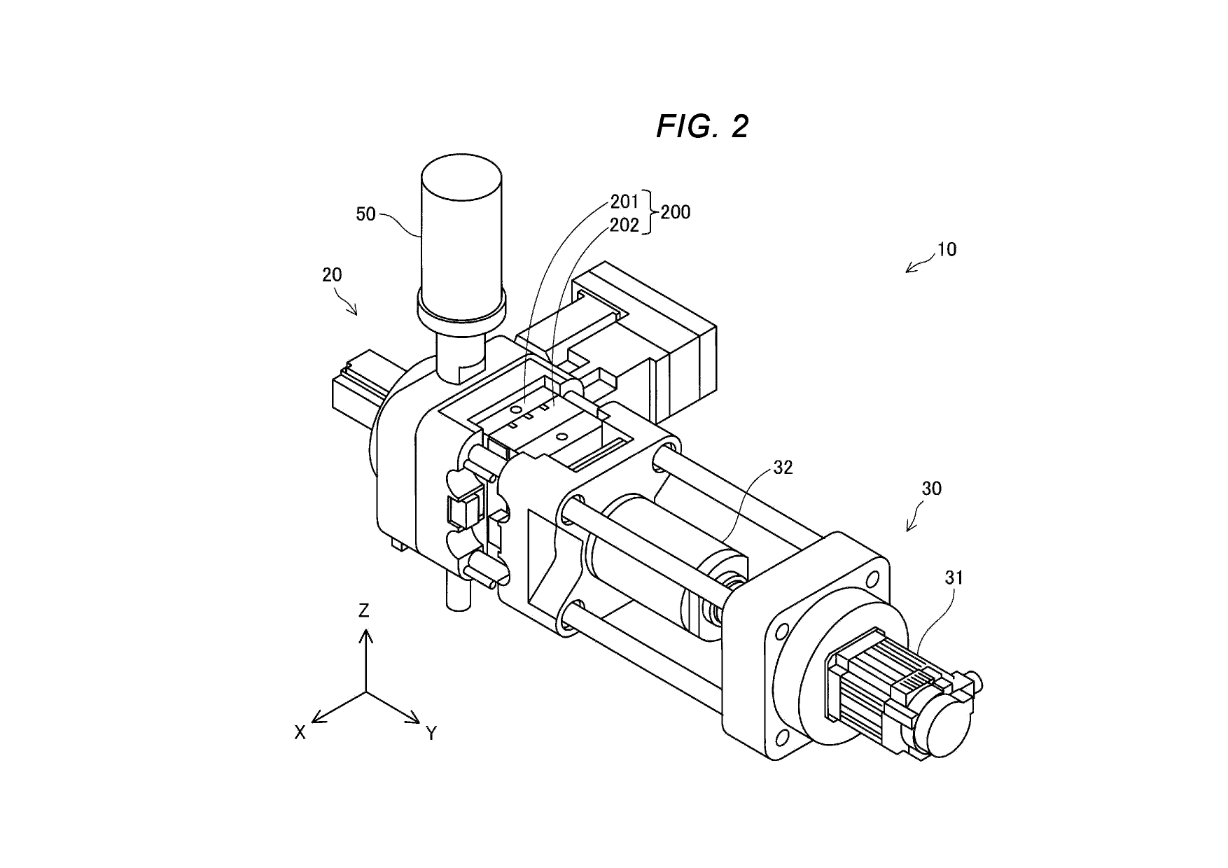

FIG. 1 is a top view illustrating a schematic configuration of an injection molding device 10. FIG. 2 is a perspective view illustrating the schematic configuration of the injection molding device 10. Arrows representing X, Y, and Z directions orthogonal to one another are illustrated in FIGS. 1 and 2. The X direction and the Y direction are directions parallel to the horizontal plane. The Z direction is a direction parallel to the vertical direction. The X, Y, and Z directions in FIGS. 1 and 2 and X, Y, and Z directions in other figures indicate the same directions. To specify an orientation, a positive or negative sign is added to the description of the direction, where "+" refers to a positive direction that is a direction indicated by an arrow, and "-" refers to a negative direction that is an opposite direction of the direction indicated by the arrow.

The injection molding device 10 includes an injection unit 20, a mold clamping device 30, and a control unit 40. The injection molding device 10 molds a molded article by injecting a plasticized material from the injection unit 20 into a molding die 200 attached to the mold clamping device 30. The control unit 40 is configured as a computer including a CPU and a memory and controls the units of the injection molding device 10 by the CPU executing a program stored in the memory. The control unit 40 may be configured by a circuit.

The molding die 200 made of metal is attached to the mold clamping device 30. The molding die 200 made of metal is referred to as mold. The molding die 200 includes a fixed die 201 and a movable die 202. The fixed die 201 is a die fixed to the injection unit 20. The movable die 202 is a die that can be advanced and retracted in a mold clamping direction with respect to the fixed die 201 by the mold clamping device 30. In the present embodiment, the mold clamping direction is the -Y direction. In the present specification, the molding die 200 is also referred to as injection molding die.

The mold clamping device 30 has a function of opening and closing the fixed die 201 and the movable die 202. Under the control of the control unit 40, the mold clamping device 30 drives a mold drive unit 31 configured by a motor to rotate a ball screw 32 and moves the movable die 202 coupled to the ball screw 32 with respect to the fixed die 201 to open and close the molding die 200.

A hopper 50 into which a material for a molded article is put is coupled to the injection unit 20. As the material for a molded article, thermoplastic resin formed in a pellet shape is used, for example. As the thermoplastic resin, acrylonitrile butadiene styrene (ABS), polycarbonate (PC), polyacetal (POM), polypropylene (PP), polybutylene terephthalate (PBT), and the like are used. The material for a molded article may contain metal or ceramic in addition to the thermoplastic resin. The supply of the material to the injection unit 20 is not limited to the supply from the hopper 50 but may be performed, for example, via a tube through which the material is pumped.

The injection unit 20 plasticizes at least a part of the material supplied from the hopper 50 to generate a plasticized material and injects the generated plasticized material into a cavity partitioned between the fixed die 201 and the movable die 202. In the present specification, "plasticizing" refers to a concept including melting and means changing from a solid to a state having fluidity. Specifically, in the case of a material in which glass transition occurs, plasticizing refers to setting the temperature of the material to the glass transition point or higher. In the case of a material in which glass transition does not occur, plasticizing means setting the temperature of the material to the melting point or higher.

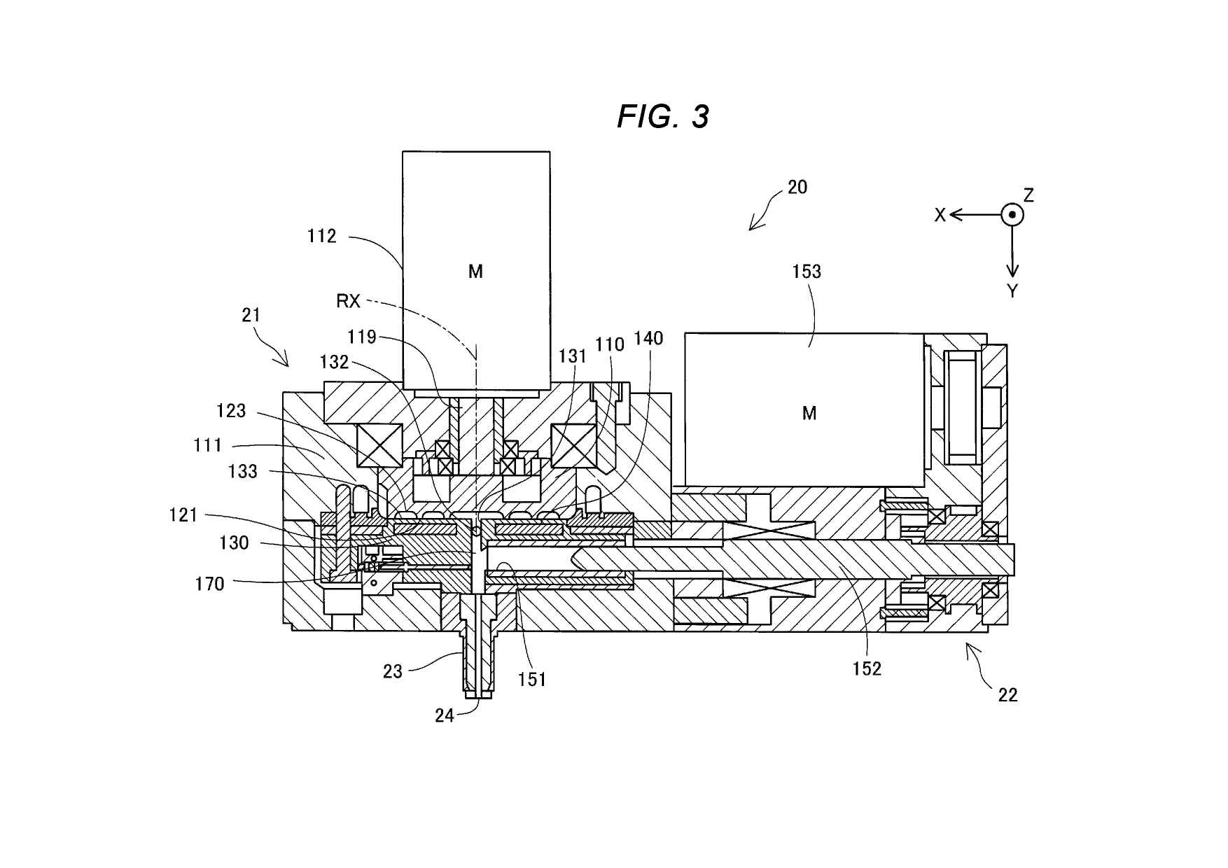

FIG. 3 is a cross-sectional view illustrating a schematic configuration of the injection unit 20. The injection unit 20 includes a plasticizing section 21, a suction and delivery section 22, and a nozzle 23 having a nozzle opening 24.

The plasticizing section 21 plasticizes at least a part of the material supplied from the hopper 50 to generate a plasticized material. The plasticizing section 21 includes a flat screw 110, a barrel 130, and a heater 140.

The flat screw 110 is housed in a screw case 111. The flat screw 110 is rotated in the screw case 111 centering on a drive shaft 119 of a drive motor 112 by the drive motor 112. A center axis RX serving as a rotation center of the flat screw 110 coincides with the center of the drive shaft 119 of the drive motor 112 in an XZ plane. In the present embodiment, axial directions of the drive shaft 119 and the central axis RX are along the Y direction. Rotation of the flat screw 110 by the drive motor 112 is controlled by the control unit 40. The flat screw 110 may be driven by the drive motor 112 via a decelerator. The flat screw 110 is also called rotor or simply called screw.

A communication hole 131 is formed at the center of the barrel 130. The communication hole 131 communicates with a flow path 170 through which the plasticized material flows. A cylinder 151 explained below and the nozzle 23 are coupled to the flow path 170. In the flow path 170, a check valve 132 is provided upstream of the cylinder 151. The check valve 132 prevents backflow of the plasticized material from the nozzle 23 side to the flat screw 110 side.

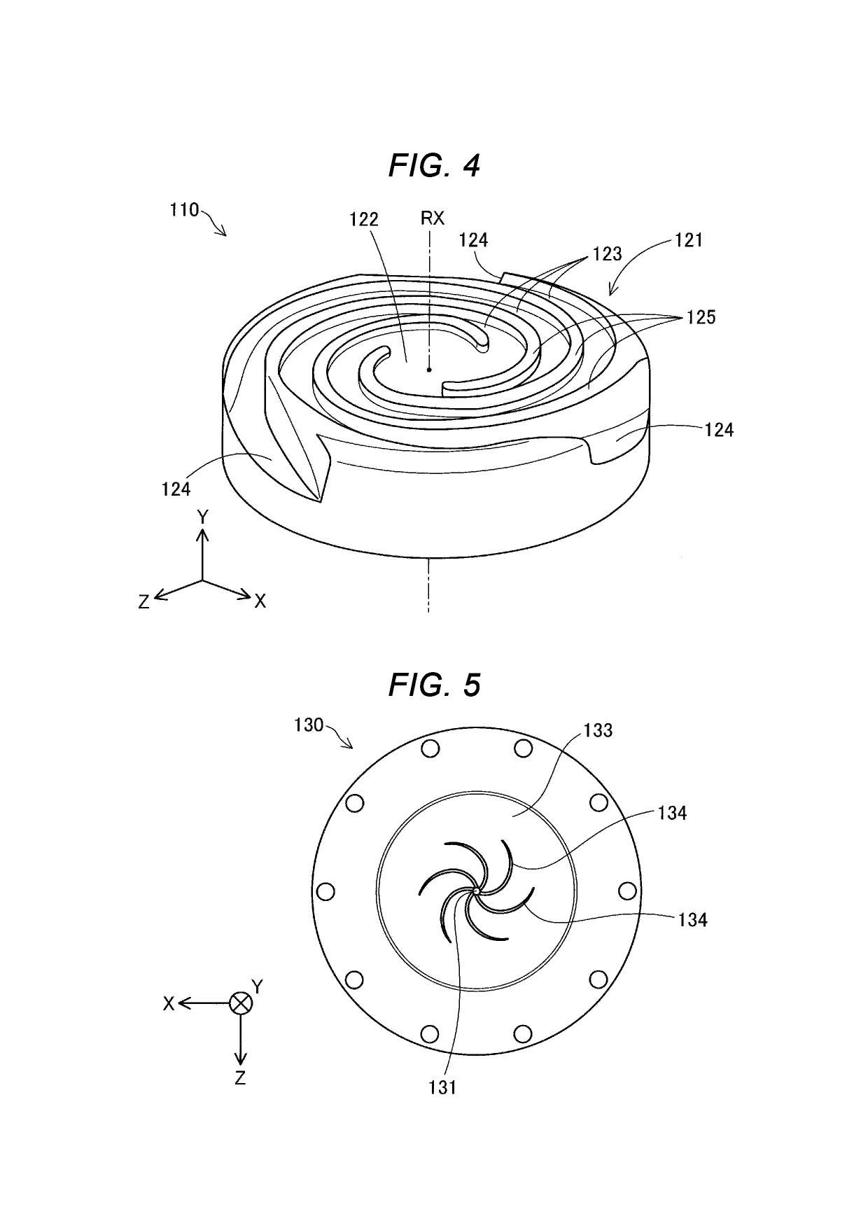

FIG. 4 is a perspective view illustrating a schematic configuration of the flat screw 110. The flat screw 110 has a substantially cylindrical shape in which length in a direction along the central axis RX is smaller than length in a direction perpendicular to the central axis RX. On a groove forming surface 121 of the flat screw 110 facing the barrel 130, spiral grooves 123 are formed centering on a center portion 122. The grooves 123 communicate with a material inlet 124 formed at a side surface of the flat screw 110. The material supplied from the hopper 50 is supplied to the grooves 123 through the material inlet 124. The grooves 123 are formed by being separated by convex ridge portions 125. FIG. 4 illustrates a case in which three grooves 123 are formed. However, the number of grooves 123 may be one or may be two or more. The grooves 123 is not limited to a spiral shape and may have a helical shape or an involute curve shape or may have a shape extending to draw an arc from the center portion 122 toward the outer circumference.

FIG. 5 is a schematic plan view of the barrel 130. The barrel 130 has a counter surface 133 facing the groove forming surface 121 of the flat screw 110. The communication hole 131 is formed at the center of the counter surface 133. On the counter surface 133, a plurality of guide grooves 134 coupled to the communication hole 131 and extending in a spiral shape from the communication hole 131 toward the outer circumference are formed. The guide grooves 134 may not be provided in the barrel 130. The guide grooves 134 may be not coupled to the communication hole 131.

The material supplied to the grooves 123 of the flat screw 110 flows along the grooves 123 and the guide grooves 134 according to the rotation of the flat screw 110 and is guided to the center portion 122 of the flat screw 110 while being plasticized between the flat screw 110 and the barrel 130 by the rotation of the flat screw 110 and heating of the heater 140. The material flowing into the center portion 122 flows out to the flow path 170 from the communication hole 131 provided at the center of the barrel 130.

As illustrated in FIG. 3, the suction and delivery section 22 includes the cylinder 151, a plunger 152, and a plunger drive section 153. The suction and delivery section 22 has a function of injecting the plasticized material in the cylinder 151 into the cavity of the molding die 200. The suction and delivery section 22 controls an injection amount, injection speed, and an injection pressure of the plasticized material from the nozzle 23 under the control of the control unit 40. The cylinder 151 is a substantially cylindrical member coupled to the flow path 170 and includes the plunger 152 therein. The plunger 152 slides on the inside of the cylinder 151 and pressure-feeds the plasticized material in the cylinder 151 to the nozzle 23. The plunger 152 is driven by the plunger drive section 153 configured by a motor.

The flow path 170 is formed in the nozzle 23. When the plunger 152 pressure-feeds the plasticized material in the cylinder 151 to the nozzle 23, the plasticized material is injected from the nozzle opening 24 of the nozzle 23 to the molding die 200.

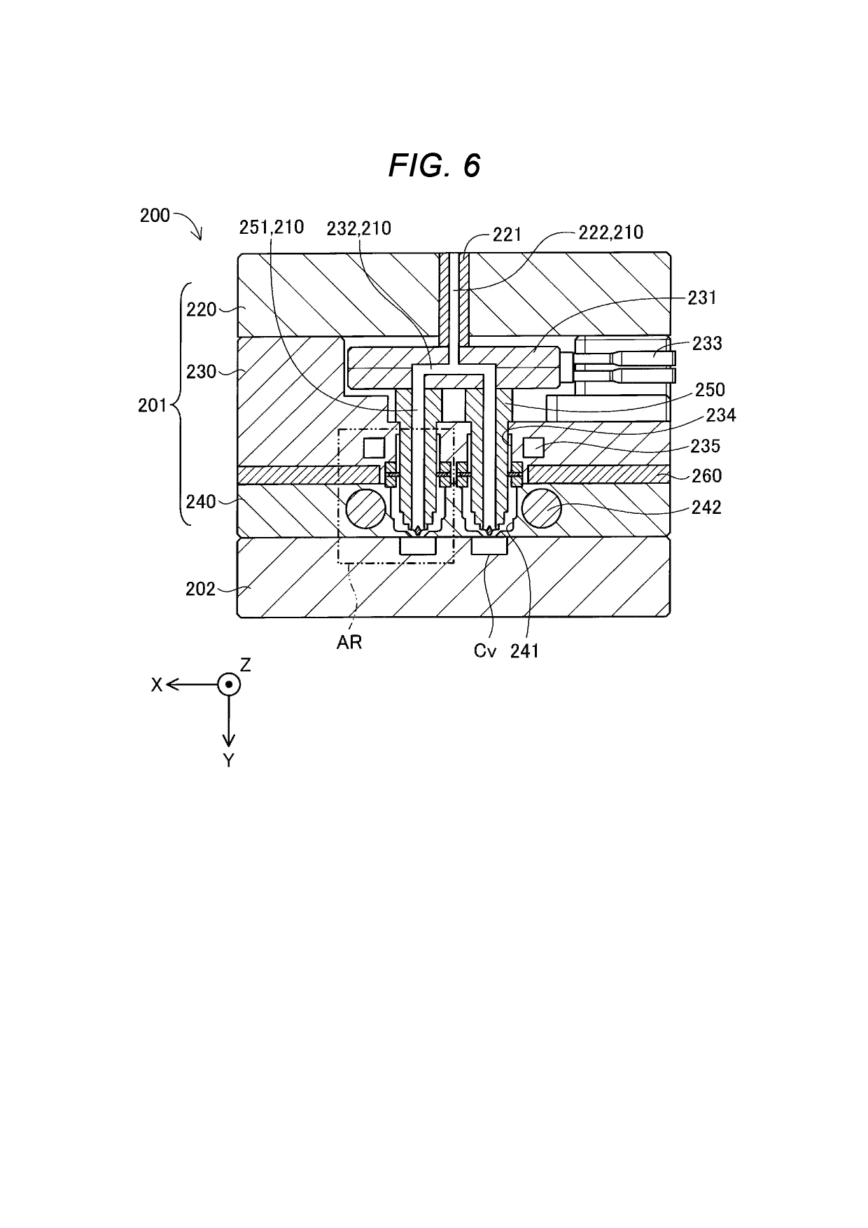

FIG. 6 is a cross-sectional view illustrating a schematic configuration of the molding die 200. The molding die 200 is configured as a molding die of a hot-runner type. An in-mold flow path 210 through which the plasticized material flows is formed on the inside of the fixed die 201. The plasticized material injected from the nozzle 23 of the injection unit 20 to the molding die 200 reaches a cavity Cv via the in-mold flow path 210. The in-mold flow path 210 is formed by a space portion such as a hole or a groove formed in a member configuring the fixed die 201. The plasticized material in the in-mold flow path 210 is heated by a heater provided in the fixed die 201 and is kept in a state of having fluidity. The "hot runner type" is also called "runner-less type".

The fixed die 201 includes an attachment plate 220, a first plate 230, a second plate 240, two probes 250, and a heat insulating member 260. The attachment plate 220 is disposed at a position closest to the injection unit 20 among members provided in the fixed die 201. The first plate 230 and the second plate 240 are disposed between the movable die 202 and the attachment plate 220 in the mold clamping direction. The first plate 230 is located between the second plate 240 and the attachment plate 220 in the mold clamping direction. The second plate 240 is located between the movable die 202 and the first plate 230 in the mold clamping direction. The attachment plate 220, the first plate 230, and the second plate 240 are fixed to one another by not-illustrated screws or the like.

A sprue bush 221 is attached to the attachment plate 220. A sprue 222 extending in the Y direction is formed in the sprue bush 221. The sprue 222 forms an end portion on the inlet side of the in-mold flow path 210. The end on the − Y direction side of the sprue 222 is equivalent to the starting end of the in-mold flow path 210. An end portion on the +Y direction side of the sprue 222 is coupled to a manifold flow path 232 in a manifold 231 explained below. The distal end of the nozzle 23 of the injection unit 20 comes into contact with the end on the − Y direction side of the sprue 222.

The manifold 231 is provided in the first plate 230. The manifold 231 is disposed on the +Y direction side of the sprue bush 221. The manifold flow path 232 is formed in the manifold 231. As explained above, the starting end of the manifold flow path 232 is coupled to the sprue 222. The manifold flow path 232 forms a part of the in-mold flow path 210 and functions as a flow path that distributes, to the probes 250, the plasticized material flowing into the molding die 200 from the nozzle 23. The manifold flow path 232 branches into two flow paths extending in different directions in the manifold 231. The branched flow paths are respectively coupled to probe flow paths 251 in the probes 250 explained below. The plasticized material in the manifold flow path 232 is heated by a cartridge heater 233 inserted into the manifold 231. The cartridge heater 233 heats the manifold 231, whereby a molten state of the plasticized material in the manifold flow path 232 is maintained. The temperature of the cartridge heater 233 is controlled by the control unit 40. The control unit 40 sets the temperature of the cartridge heater 233 to, for example, 400°C.

The first plate 230 includes first through holes 234 that are holes penetrating the first plate 230 in the mold clamping direction. Parts of the probes 250 are disposed on the insides of the first through holes 234. In the present embodiment, the first plate 230 is formed of SUS304. The first plate 230 may be formed of metal other than SUS304, ceramic, or the like. In the present specification, the first plate 230 is also referred to as spacer.

A refrigerant pipe 235 through which a refrigerant flows is embedded in the first plate 230. The refrigerant pipe 235 is coupled to a not-illustrated refrigerant pump that supplies the refrigerant to the refrigerant pipe 235. As the refrigerant, for example, liquid such as water or oil or a gas such as carbon dioxide can be used. The temperature of the refrigerant flowing through the refrigerant pipe 235 is controlled by the control unit 40. The control unit 40 sets the temperature of the refrigerant flowing through the refrigerant pipe 235 to, for example, 50°C. The first plate 230 is cooled by the refrigerant flowing through the refrigerant pipe 235. For that reason, it is possible to prevent the heat of the manifold 231 from being transferred to the second plate 240 to excessively raise the temperature of the second plate 240.

The second plate 240 includes second through holes 241 that are holes penetrating the second plate 240 in the mold clamping direction. The second through holes 241 are formed to communicate with the first through holes 234 of the first plate 230. Parts of the probes 250 are disposed on the insides of the second through holes 241. In the present embodiment, the second plate 240 is formed of carbon steel. The second plate 240 may be formed of metal other than carbon steel, ceramic, or the like. The second plate 240 is preferably formed of a material having higher thermal conductivity than the first plate 230. In the second plate 240, second plate heaters 242 that heat the second plate 240 are provided. The temperature of the second plate heaters 242 is controlled by the control unit 40. The control unit 40 controls the temperature of the second plate heaters 242 to the temperature lower than the temperature of the cartridge heater 233. The control unit 40 sets the temperature of the second plate heaters 242 to, for example, 200°C. In the present specification, the second plate 240 is also referred to as cavity plate.

The probes 250 inject the plasticized material toward the cavity Cv formed by the fixed die 201 and the movable die 202. The probes 250 are configured as hot runner nozzles of an open-gate type. In the present embodiment, the probes 250 are formed of iron. The probes 250 may be formed of metal other than iron. As explained above, the probes 250 are disposed on the insides of the first through holes 234 and the second through holes 241. In other words, the probes 250 are inserted into the first through holes 234 and the second through holes 241. The probe flow paths 251 extending in the Y direction are formed in the probes 250. The probe flow paths 251 form end portions on the outlet side of the in-mold flow path 210. End portions on the − Y direction side of the probe flow paths 251 are coupled to the manifold flow path 232 as explained above. The probes 250 may be configured as hot runner nozzles of a valve gate type.

In the present embodiment, as illustrated in FIG. 6, the fixed die 201 includes two probes 250, two first through holes 234, and two second through holes 241. One probe 250 is disposed on the insides of one first through hole 234 and one second through hole 241. Structures of the respective probes 250, the respective first through holes 234, and the respective second through holes 241 are the same. In another embodiment, the fixed die 201 may include one probe 250 or may include three or more probes 250. In this case, the first plate 230 includes the first through holes 234 as many as the number of probes 250 and the second plate 240 includes the second through holes 241 as many as the number of probes 250.

The heat insulating member 260 is provided between the second plate 240 and the first plate 230 in the mold clamping direction and suppresses heat transfer between the second plate 240 and the first plate 230. The heat insulating member 260 is made of, for example, glass fibers or ceramic.

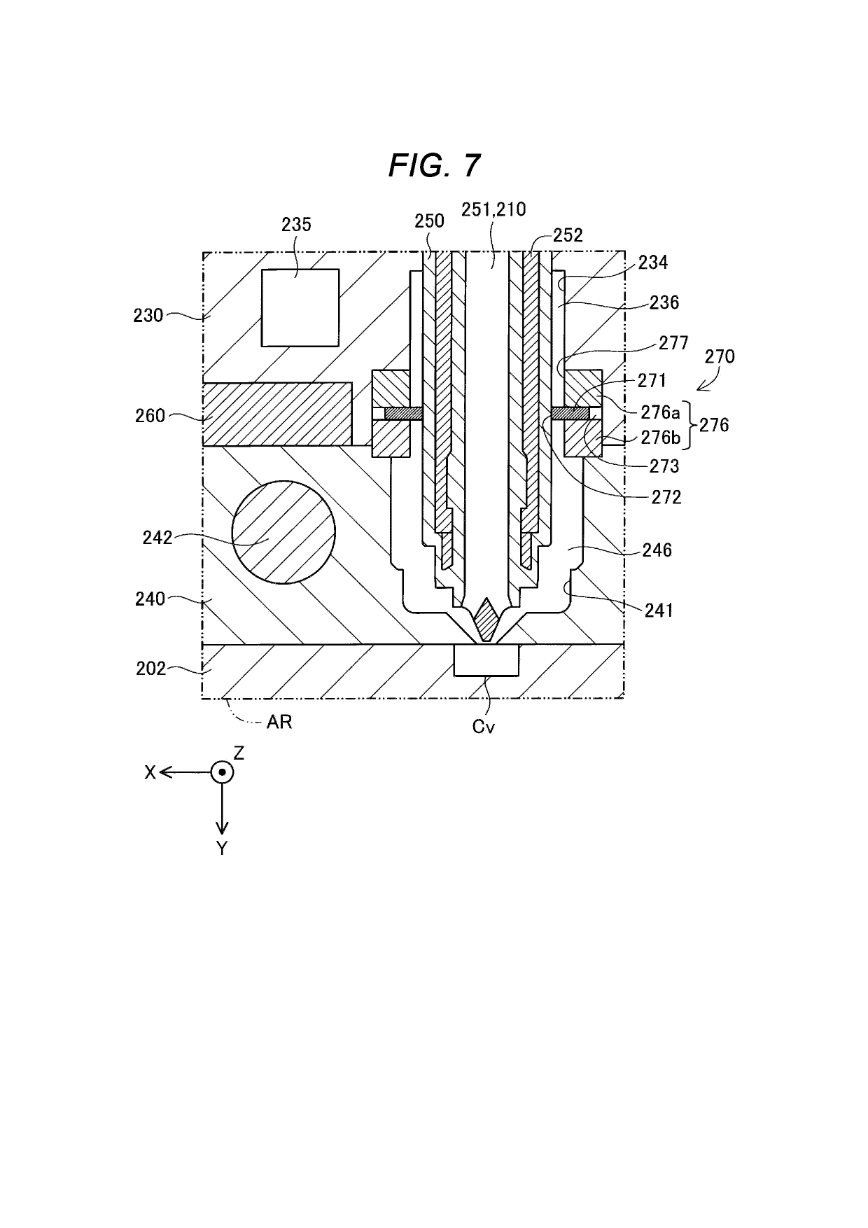

FIG. 7 is an enlarged view illustrating a partial range AR of FIG. 6. As explained above, the probe 250 is disposed in the first through hole 234 and the second through hole 241. A first space 236 is formed between an outer peripheral surface of the probe 250 and an inner wall surface of the first through hole 234. A second space 246 is formed between the outer peripheral surface of the probe 250 and an inner wall surface of the second through hole 241. The probe 250 includes a probe heater 252. The probe heater 252 is provided in the probe 250 to surround the probe flow path 251. The probe heater 252 heats the probe 250, whereby the molten state of the plasticized material in the probe flow path 251 is maintained.

The fixed die 201 further includes a partition member 270. The partition member 270 is disposed in the first through hole 234 or the second through hole 241 to surround the probe 250 and partitions the first space 236 and the second space 246. The partition member 270 includes a first member 271 and a second member 276. The shapes of the first member 271 and the second member 276 are ring shapes. The second member 276 is configured from a pair of ring-shaped members. In the following explanation, the second member 276 disposed on the −Y direction side is also referred to as an upstream second member 276a and the second member 276 disposed on the +Y direction side is also referred to as a downstream second member 276b. The first member 271 is sandwiched by the second member 276 in a direction along the first through hole 234 and the second through hole 241. In the present embodiment, the direction along the first through hole 234 and the second through hole 241 is the Y direction. In other words, the first member 271 is sandwiched between the upstream second member 276a and the downstream second member 276b. In the present embodiment, the first member 271 is disposed in the first through hole 234, the upstream second member 276a is disposed in the first through hole 234, and the downstream second member 276b is disposed in the first through hole 234 and the second through hole 241.

The thermal conductivity of the second member 276 is smaller than the thermal conductivity of the first member 271. The thermal expansion coefficient of the second member 276 is smaller than the thermal expansion coefficients of the probe 250 and the first member 271. The thermal expansion coefficient of the probe 250 and the thermal expansion coefficient of the first member 271 are preferably about the same degree. In the present embodiment, the first member 271 is formed of SUS304 and the second member 276 is formed of zirconia. The first member 271 and the second member 276 only have to be formed of materials, thermal conductivities and thermal expansion coefficients of which satisfy the relationship explained above. The first member 271 may be formed of metal other than SUS304 or ceramic and the second member 276 may be formed of metal other than zirconia or ceramic. The second member 276 is preferably formed of a material having high strength.

The first member 271 includes a fourth through hole 272 that is a hole penetrating the first member 271 in the Y direction. The second member 276 has a third through hole 277 that is a hole penetrating the second member 276 in the Y direction. The first member 271 is disposed in the first through hole 234 such that the probe 250 is located on the inside of the fourth through hole 272. The second member 276 is disposed in the first through hole 234 and the second through hole 241 such that the probe 250 is located on the inside of the third through hole 277. That is, the first member 271 and the second member 276 surround the probe 250. The outer peripheral surface of the probe 250 and an inner wall surface of the fourth through hole 272 are in contact with each other. A space is formed between the outer peripheral surface of the probe 250 and an inner wall surface of the third through hole 277.

The outer diameter of the second member 276 is larger than the outer diameter of the first member 271. A third space 273 is formed between an outer peripheral surface of the first member 271 and the inner wall surface of the first through hole 234. That is, the first member 271 is not in contact with the first plate 230. An outer peripheral surface of the second member 276 is in contact with the inner wall surface of the first through hole 234 and the inner wall surface of the second through hole 241. Specifically, an outer peripheral surface of the upstream second member 276a is in contact with the inner wall surface of the first through hole 234 and an outer peripheral surface of the downstream second member 276b is in contact with the inner wall surface of the first through hole 234 and the inner wall surface of the second through hole 241. That is, the second member 276 is in contact with the first plate 230 and the second plate 240.

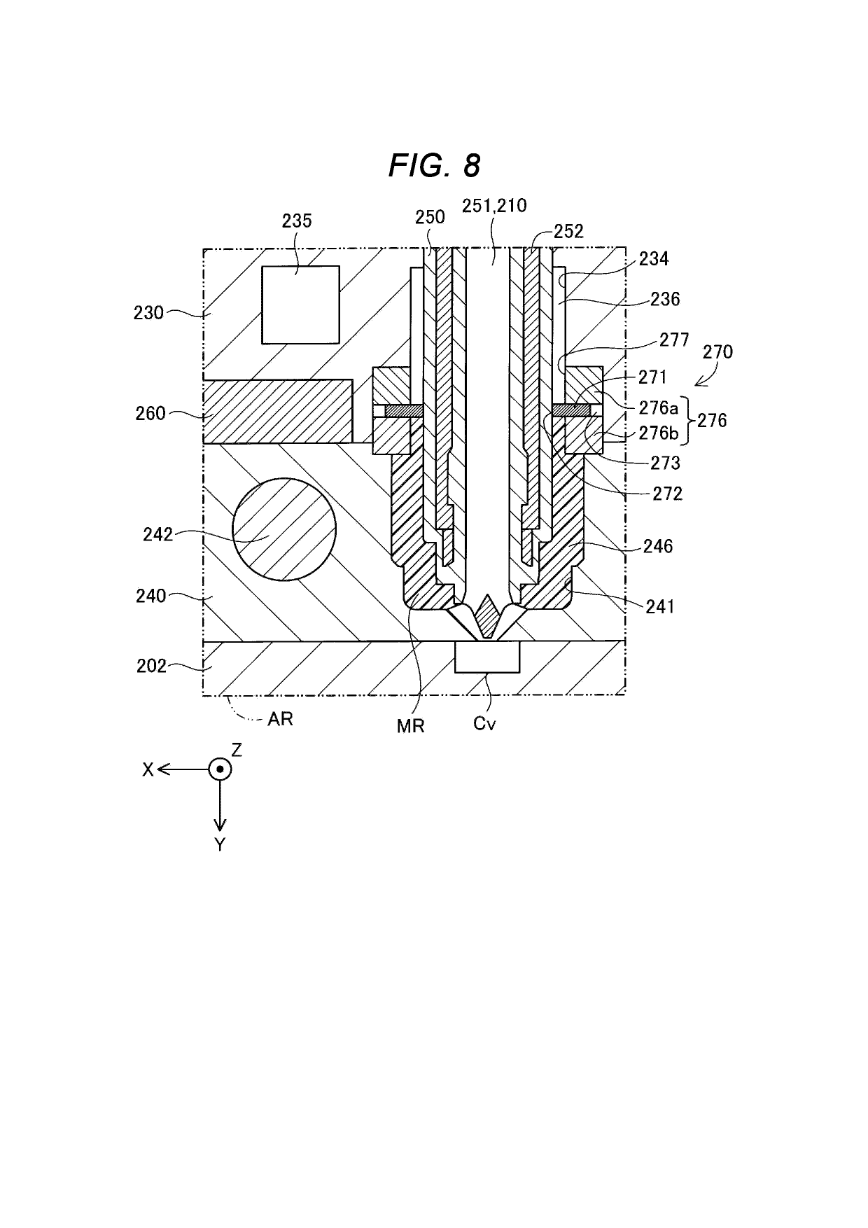

FIG. 8 is a diagram illustrating a state in which a plasticized material MR is filled in the second space 246. In the injection molding device 10, before the plasticized material MR is injected into the cavity Cv to mold a molded article, the plasticized material MR is filled in a space formed between the probe 250 and a through hole of the fixed die 201 into which the probe 250 is inserted. That is, after the plasticized material MR is filled in the space, the plasticized material MR is injected into the cavity Cv. The molded article is taken out from the molding die 200 after the plasticized material MR filled in the space is solidified. In the present specification, the plasticized material MR filled in the space, which is formed between the probe 250 and the through hole of the fixed die 201 into which the probe 250 is inserted, and solidified is referred to as resin cap. As illustrated in FIG. 8, since the first space 236 and the second space 246 are partitioned by the partition member 270, the plasticized material MR is filled in the second space 246 but the plasticized material MR is not filled in the first space 236. Therefore, the resin cap is formed in the second space 246 but is not formed in the first space 236.

According to the first embodiment explained above, the first space 236 formed between the outer peripheral surface of the probe 250 and the inner wall surface of the first through hole 234 and the second space 246 formed between the outer peripheral surface of the probe 250 and the inner wall surface of the second through hole 241 are partitioned by the partition member 270. For that reason, when the plasticized material is filled in the space between the probe 250 and the through hole of the fixed die 201 into which the probe 250 is inserted, the plasticized material is filled in the second space 246 but is not filled in the first space 236. Therefore, since the resin cap is not formed in the first space 236, it is possible to remove the resin cap from the fixed die 201 only by removing the resin cap formed in the second space 246. As explained above, it is possible to easily remove the resin cap from the fixed die 201.

In the present embodiment, the thermal conductivity of the second member 276 is smaller than the thermal conductivity of the first member 271. The first member 271 is sandwiched by the second member 276 in the direction along the first through hole 234 and the second through hole 241. For that reason, it is possible to prevent the heat of the probe 250 from being transferred to the first plate 230 or the second plate 240 via the first member 271.

In the present embodiment, the third space 273 is formed between the outer peripheral surface of the first member 271 and the inner wall surface of the first through hole 234. For that reason, it is possible to prevent the heat of the probe 250 from being transferred to the first plate 230 via the first member 271.

In the present embodiment, the space is formed between the outer peripheral surface of the probe 250 and the inner wall surface of the third through hole 277. For that reason, when the probe 250 thermally expands, it is possible to reduce the possibility that the probe 250 and the second member 276 come into contact with each other and the probe 250 or the second member 276 is damaged.

In the present embodiment, the thermal expansion coefficient of the second member 276 is smaller than the thermal expansion coefficients of the probe 250 and the first member 271. For that reason, it is possible to prevent the entire partition member 270 from expanding. When the thermal expansion coefficient of the probe 250 and the thermal expansion coefficient of the first member 271 are the same degree, it is possible to prevent a gap from being formed between the outer peripheral surface of the probe 250 and the inner wall surface of the fourth through hole 272 when the probe 250 and the first member 271 thermally expand.

In the present embodiment, the injection molding device 10 includes the heat insulating member 260 between the first plate 230 and the second plate 240. For that reason, it is possible to prevent heat from being transferred between the first plate 230 and the second plate 240.

### B. Other Embodiments:

(B-1) In the above embodiment, the first member 271 is disposed in the first through hole 234, the upstream second member 276a is disposed in the first through hole 234, and the downstream second member 276b is disposed in the first through hole 234 and the second through hole 241. In contrast, the first member 271 may be disposed in the first through hole 234 and the second through hole 241, the upstream second member 276a may be disposed in the first through hole 234, and the downstream second member 276b may be disposed in the second through hole 241. In this case, the third space 273 is formed between the outer peripheral surface of the first member 271 and the inner wall surfaces of the first through hole 234 and the second through hole 241.

(B-2) In the above embodiment, the first member 271 is disposed in the first through hole 234, the upstream second member 276a is disposed in the first through hole 234, and the downstream second member 276b is disposed in the first through hole 234 and the second through hole 241. In contrast, the first member 271 may be disposed in the second through hole 241, the upstream second member 276a may be disposed in the first through hole 234 and the second through hole 241, and the downstream second member 276b may be disposed in the second through hole 241. In this case, the third space 273 is formed between the outer peripheral surface of the first member 271 and the inner wall surface of the second through hole 241.

(B-3) In the above embodiment, the first member 271 is disposed in the first through hole 234, the upstream second member 276a is disposed in the first through hole 234, and the downstream second member 276b is disposed in the first through hole 234 and the second through hole 241. In contrast, the entire partition member 270 may be disposed in the first through hole 234.

(B-4) In the above embodiment, the first member 271 is disposed in the first through hole 234, the upstream second member 276a is disposed in the first through hole 234, and the downstream second member 276b is disposed in the first through hole 234 and the second through hole 241. In contrast, the entire partition member 270 may be disposed in the second through hole 241.

(B-5) In the above embodiment, the partition member 270 includes the first member 271 and the second member 276. In contrast, the partition member 270 may be configured from one member.

(B-6) In the above embodiment, the thermal conductivity of the second member 276 is smaller than the thermal conductivity of the first member 271. In contrast, the thermal conductivity of the second member 276 may be larger than the thermal conductivity of the first member 271.

(B-7) In the above embodiment, the third space 273 is formed between the outer peripheral surface of the first member 271 and the inner wall surface of the first through hole 234 or the second through hole 241. In contrast, the third space 273 may not be formed between the outer peripheral surface of the first member 271 and the inner wall surface of the first through hole 234 or the second through hole 241. That is, the first member 271 and the first plate 230 or the second plate 240 may be in contact with each other.

(B-8) In the above embodiment, the shapes of the first member 271 and the second member 276 are the ring shapes. In contrast, the shapes of the first member 271 and the second member 276 may not be ring shapes. For example, the first member 271 may have a rectangular parallelepiped shape including the fourth through hole 272 and the second member 276 may have a rectangular parallelepiped shape including the third through hole 277.

(B-9) In the above embodiment, the space is formed between the outer peripheral surface of the probe 250 and the inner wall surface of the third through hole 277. In contrast, a space may not be formed between the outer peripheral surface of the probe 250 and the inner wall surface of the third through hole 277. That is, the outer peripheral surface of the probe 250 and the second member 276 may be in contact with each other.

(B-10) In the above embodiment, the thermal expansion coefficient of the second member 276 is smaller than the thermal expansion coefficients of the probe 250 and the first member 271. In contrast, the thermal expansion coefficient of the second member 276 may be larger than the thermal expansion coefficient of the probe 250 or the first member 271.

(B-11) In the above embodiment, the fixed die 201 includes the heat insulating member 260. In contrast, the fixed die 201 may not include the heat insulating member 260.

### C. Other Aspects:

The disclosure is not limited to the embodiments explained above, and can be implemented in various aspects to the extent that the various aspects do not depart from the intent of the disclosure. For example, the disclosure can also be implemented in the following aspects. To solve some or all of the problems described in the disclosure, or to achieve some or all of the effects of the disclosure, technical features of the embodiments explained above that correspond to the technical features in each of the following aspects can be replaced or combined as appropriate. Further, the technical features can be deleted as appropriate unless described as essential features in the present specification.

(1) According to a first aspect of the present disclosure, an injection molding device is provided. The injection molding device includes: a molding die including a fixed die and a movable die; a probe in which a probe flow path through which a plasticized material flows is provided, the probe injecting the plasticized material toward a cavity formed by the fixed die and the movable die; and a partition member. The fixed die includes: a first plate in which a first through hole is provided; and a second plate located between the first plate and the movable die, a second through hole communicating with the first through hole being provided in the second plate, the probe is disposed in the first through hole and the second through hole, a first space is formed between an outer peripheral surface of the probe and an inner wall surface of the first through hole, a second space is formed between the outer peripheral surface of the probe and an inner wall surface of the second through hole, and the partition member is disposed in the first through hole or the second through hole to surround the probe and partitions the first space and the second space.

According to the aspect explained above, since a resin cap is not formed in the first space, it is possible to easily remove the resin cap from the fixed die.

(2) In the above aspect, the partition member may include a first member and a second member, and the first member may be sandwiched by the second member in a direction along the first through hole and the second through hole.

(3) In the above aspect, a thermal conductivity of the second member may be smaller than a thermal conductivity of the first member.

According to the aspect explained above, it is possible to prevent the heat of the probe from being transferred to the first plate or the second plate via the first member.

(4) In the above aspect, the first member and the second member may have a ring shape surrounding the probe, an outer diameter of the second member may be larger than an outer diameter of the first member, and a third space may be formed between an outer peripheral surface of the first member and the inner wall surface of the first through hole or the second through hole.

According to the aspect explained above, it is possible to prevent the heat of the probe from being transferred to the first plate or the second plate via the first member.

(5) In the above aspect, the second member may include a third through hole, the probe may be disposed in the third through hole, and a space may be formed between the outer peripheral surface of the probe and an inner wall surface of the third through hole.

According to the aspect explained above, when the probe thermally expands, it is possible to reduce the possibility that the probe and the second member come into contact with each other and the probe or the second member is damaged.

(6) In the above aspect, a thermal expansion coefficient of the second member may be smaller than thermal expansion coefficients of the probe and the first member.

According to the aspect explained above, it is possible to prevent the entire partition member from expanding.

(7) In the above aspect, the injection molding device may include a heat insulating member between the first plate and the second plate.

According to the aspect explained above, it is possible to prevent heat from being transferred between the first plate and the second plate.

(8) According to a second aspect of the present disclosure, an injection molding die is provided. The injection molding die includes: a fixed die; a movable die; a probe in which a probe flow path through which a plasticized material flows is provided, the probe injecting the plasticized material toward a cavity formed by the fixed die and the movable die; and a partition member. The fixed die includes: a first plate in which a first through hole is provided; and a second plate located between the first plate and the movable die, a second through hole communicating with the first through hole being provided in the second plate, the probe is disposed in the first through hole and the second through hole, a first space is formed between an outer peripheral surface of the probe and an inner wall surface of the first through hole, a second space is formed between the outer peripheral surface of the probe and an inner wall surface of the second through hole, and the partition member is disposed in the first through hole or the second through hole to surround the probe and partitions the first space and the second space.

According to the aspect explained above, since a resin cap is not formed in the first space, it is possible to easily remove the resin cap from the fixed die.

What is claimed is:

1. An injection molding device comprising:
a molding die including a fixed die and a movable die;
a probe in which a probe flow path through which a plasticized material flows is provided, the probe injecting the plasticized material toward a cavity formed by the fixed die and the movable die; and
a partition member, wherein the fixed die includes:
a first plate in which a first through hole is provided; and
a second plate located between the first plate and the movable die, a second through hole communicating with the first through hole being provided in the second plate,
the probe is disposed in the first through hole and the second through hole,
a first space is formed between an outer peripheral surface of the probe and an inner wall surface of the first through hole,
a second space is formed between the outer peripheral surface of the probe and an inner wall surface of the second through hole, and
the partition member is disposed in the first through hole or the second through hole to surround the probe and partitions the first space and the second space.

2. The injection molding device according to claim 1, wherein
the partition member includes a first member and a second member, and
the first member is sandwiched by the second member in a direction along the first through hole and the second through hole.

3. The injection molding device according to claim 2, wherein a thermal conductivity of the second member is smaller than a thermal conductivity of the first member.

4. The injection molding device according to claim 2, wherein
the first member and the second member have a ring shape surrounding the probe,
an outer diameter of the second member is larger than an outer diameter of the first member, and
a third space is formed between an outer peripheral surface of the first member and the inner wall surface of the first through hole or the second through hole.

5. The injection molding device according to claim 2, wherein
the second member includes a third through hole,
the probe is disposed in the third through hole, and
a space is formed between the outer peripheral surface of the probe and an inner wall surface of the third through hole.

6. The injection molding device according to claim 2, wherein a thermal expansion coefficient of the second member is smaller than thermal expansion coefficients of the probe and the first member.

7. The injection molding device according to claim 1, wherein the injection molding device includes a heat insulating member between the first plate and the second plate.

8. An injection molding die comprising:
a fixed die;
a movable die;
a probe in which a probe flow path through which a plasticized material flows is provided, the probe injecting the plasticized material toward a cavity formed by the fixed die and the movable die; and
a partition member, wherein the fixed die includes:
a first plate in which a first through hole is provided; and
a second plate located between the first plate and the movable die, a second through hole communicating with the first through hole being provided in the second plate,
the probe is disposed in the first through hole and the second through hole,
a first space is formed between an outer peripheral surface of the probe and an inner wall surface of the first through hole,
a second space is formed between the outer peripheral surface of the probe and an inner wall surface of the second through hole, and
the partition member is disposed in the first through hole or the second through hole to surround the probe and partitions the first space and the second space.
